(19) United States
(12) Patent Application Publication
(10) Pub. No.: US 2021/0347617 A1
(43) Pub. Date: Nov. 11, 2021

(54) ENGAGING AN ELEMENT

(71) Applicant: Autoguide, LLC., Chelmsford, MA (US)

(72) Inventors: Jerrar Bukhari, Chelmsford, MA (US); Tyler Barron, Chelmsford, MA (US); Justin Holwell, Chelmsford, MA (US)

(21) Appl. No.: 16/871,367

(22) Filed: May 11, 2020

(51) Int. Cl. B66F 9/06; G05D 1/02; B66F 9/075

(52) U.S. Cl. CPC B66F 9/063; G05D 1/0248; G05D 2201/0216; G05D 1/0255; B66F 9/0755; G05D 1/0251

(57) ABSTRACT

An example method of manipulating an element using an autonomous vehicle includes the following operations: following engagement with the element and during movement of the autonomous vehicle, detecting relative movement between the autonomous vehicle and the element; in response to detecting the relative movement, making a determination that the engagement is inadequate for the autonomous vehicle to continue manipulating the element; and controlling the autonomous vehicle based on the determination.

### TECHNICAL FIELD

This specification relates generally to examples of a mobile robot configured to engage elements in an environment.

### BACKGROUND

Forklifts or other drivable machinery may be used to lift elements in a space, such as a warehouse or manufacturing facility, and to move those elements from one location to another location. Examples of elements include pallets and containers. An example pallet includes a flat transport structure that supports goods during lifting. An example container includes a transportable structure having one or more vertical walls and having an inter-locking mechanism designed to prevent relative motion between the elements.

### SUMMARY

An example method of manipulating an element using an autonomous vehicle includes the following operations: following engagement with the element and during movement of the autonomous vehicle, detecting relative movement between the autonomous vehicle and the element; in response to detecting the relative movement (for example, during full engagement), making a determination that the engagement is inadequate for the autonomous vehicle to continue manipulating the element; and controlling the autonomous vehicle based on the determination. The method may also include one or more of the following features, either alone or in combination.

The method may include, prior to engagement with the element, detecting relative movement between the autonomous vehicle and the element; and controlling the autonomous vehicle to continue to move based on detecting relative movement prior to engagement. The relative movement may be detected by detecting a distance between the autonomous vehicle and the element during movement of the autonomous vehicle. The autonomous vehicle may include an end-effector configured to engage with the element. The distance may indicate whether the end-effector is fully engaged with the element, partially engaged with the element, or disengaged from the element.

The engagement may be deemed inadequate when the autonomous vehicle is moving forward and the element moves relative to the autonomous vehicle causing the distance to change. The engagement may be deemed inadequate when the autonomous vehicle is moving backward and the element moves relative to the autonomous vehicle causing the distance to change. Controlling the autonomous vehicle may include stopping movement of the autonomous vehicle in either forward or backward directions when the engagement is deemed inadequate.

The relative movement may be detected by detecting a distance between the autonomous vehicle and the element during movement of the autonomous vehicle. Detecting the distance may be performed using one or more of the following, or a combination thereof: a light detection and ranging (LIDAR) system comprised of one or more LIDAR sensors, one or more three-dimensional (3D) cameras, or one or more ultrasonic sensors. Detecting that the autonomous vehicle is moving may be based on encoders that detect tire rotation. Detecting that the autonomous vehicle is moving may implemented using laser-based detection relative to the environment. Detecting that the autonomous vehicle is moving may be performed using a 3D camera.

An example system includes an autonomous vehicle having a sensor to generate data based on relative movement between the autonomous vehicle and an element.

The autonomous vehicle also includes an end-effector to engage the element. A control system is configured to perform operations that include: following full engagement between the end-effector and the element and during movement of the autonomous vehicle, receiving the data from the sensor based on the relative movement between the autonomous vehicle and the element; in response to the relative movement, making a determination that the engagement is inadequate for the autonomous vehicle to continue manipulating the element; and controlling the autonomous vehicle based on the determination. The system may include one or more of the following features, either alone or in combination.

The control system may be configured to perform operations that include: prior to the full engagement with the element, receiving the data from the sensor based on relative movement between the autonomous vehicle and the element; and controlling the autonomous vehicle to continue to move based on the relative movement prior to engagement. The data may represent a distance between the autonomous vehicle and the element during movement of the autonomous vehicle. The distance may indicate whether the end-effector is fully engaged with the element, partially engaged with the element, or disengaged from the element. The engagement may be inadequate when the autonomous vehicle is moving forward and the element moves relative to the autonomous vehicle causing the distance to change. The engagement may be inadequate when the autonomous vehicle is moving backward and the element moves relative to the autonomous vehicle causing the distance to change.

Controlling the autonomous vehicle may include stopping movement of the autonomous vehicle in either forward or backward directions. The sensor may be or include one or more LIDAR sensors, one or more 3D cameras, and/or one or more ultrasonic sensors. The autonomous vehicle may include encoders that detect tire rotation, which is used to identify movement of the autonomous vehicle. Data representing the tire rotation is provided to the control system. The control system uses this data to identify movement of the autonomous vehicle.

Any two or more of the features described in this specification, including in this summary section, can be combined to form implementations not specifically described herein.

The example vehicles and techniques described herein, or portions thereof, can be implemented using, or controlled by, a computer program product that includes instructions that are stored on one or more non-transitory machine-readable storage media, and that are executable on one or more processing devices to control (e.g., coordinate) the operations described herein. The example vehicles and techniques described herein, or portions thereof, can be implemented as an apparatus or electronic system that can include one or more processing devices and memory to store executable instructions to implement various operations.

The details of one or more implementations are set forth in the accompanying drawings and the description below. Other features, objects, and advantages will be apparent from the description and drawings, and from the claims.

### DESCRIPTION OF THE DRAWINGS

FIG. 1 is a photorealistic diagram showing a perspective view of an example autonomous vehicle.

FIG. 2 is an illustration showing six degrees of freedom.

FIG. 3 is block diagram showing a perspective view of the autonomous vehicle of FIG. 1.

FIG. 4 is a flowchart showing operations included in an example process for detecting an element using an autonomous vehicle.

FIG. 5 is a photorealistic diagram showing a perspective view of an example stack of pallets.

FIG. 6 is a diagram show a perspective view of an example rack that may be used for stacking elements.

FIG. 7 is a flowchart showing operations included in an example process for detecting relative movement between a robot and an element.

FIG. 8 is a block diagram of a robot and a pallet, which shows different levels of engagement between the robot and the pallet.

FIG. 9 is a block diagram of a robot and a pallet, which shows full engagement between the robot and the pallet.

Like reference numerals in different figures indicate like elements.

### DETAILED DESCRIPTION

Described herein are examples of techniques for manipulating elements in an environment using an autonomous vehicle. The techniques may include operations to identify the element based on captured image data prior to engaging the element. The autonomous vehicle's engagement with the element may be analyzed to determine if the engagement is adequate. If the engagement is deemed to be inadequate, then the autonomous vehicle may be controlled to disengage and reengage the element.

Autonomous vehicles used as examples herein include mobile robots (or simply “robots”); however, any appropriate type of autonomous vehicle may be used including, but not limited to, self-driving machinery or stationary robots. The elements used as examples herein include pallets and containers; however, any appropriate types of elements may be used including, but not limited to, boxes, racks, crates, or bins. As noted, an example pallet includes a flat transport structure that supports goods during lifting. A pallet also includes a mechanism called a socket that the robot's end-effectors may enter and that are used to connect to, and to lift, the pallet. An example container includes a transportable structure having one or more vertical walls and having an inter-locking mechanism designed to prevent relative motion.

An example autonomous vehicle, such as a robot, includes a body configured for movement along a surface such as the floor of a warehouse. After a first element is detected, the end-effector, such as a fork containing one or more tines, is configured to engage and to lift the element. For example, the first element may be a pallet that the end-effector lifts and moves off of, or onto. a second element such as a stack of pallets or a rack. A control system, which may include one or more processing devices examples of which are described herein, is configured—for example programmed—to control the end-effector, the robot body, or both the end-effector and the robot body to move in three or more degrees of freedom—for example, in at least four degrees of freedom—to stack the first element on top of the second element or to lift the first element off of the second element and move it away from the second element. The control system may be on-board the autonomous vehicle, remote from the autonomous vehicle, or a combination of on-board and remote. The control system may use the information from various sensors to execute the operations to detect the first element, the second element, or both, and then to control the autonomous vehicle to move the first element relative to the second element as described herein.

In an example, stacking an element may include placing the first element on top of the second element. Operations executed to perform the stacking may include, but are not limited to, the following: moving the first element to align a first feature such as a corner of the first element to a second feature such as a corner of a second element, moving the first element to align a second feature of the first element to a fourth feature of the second element and, following these alignments, moving the first element into contact with the second element so that the first feature mates to the third feature and the second feature mates to the fourth feature. Other processes may be performed to place elements on a stack, a rack, or other appropriate location.

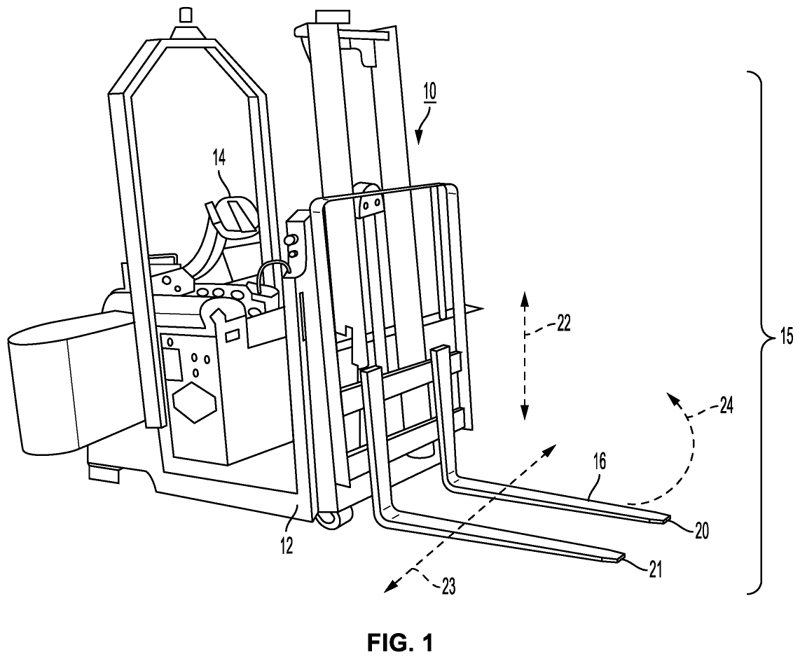

FIG. 1 shows an example of a robot 10 that is configured to move in multiple degrees of freedom to lift elements and to stack one element on top of another element. In this example, robot 10 is autonomously-controllable even though it includes mechanisms 14 for manual control. In an example, autonomously-controllable includes the robot moving of its own accord based on sensor inputs and, in some cases, inputs from a remote system such as a fleet control system. Robot 10 includes a body 12 having wheels (not shown) to enable robot 10 to travel across a surface, such as the floor of a warehouse, a factory, or other terrain. Robot 10 also includes a support area 15 configured to support the weight of an element, such as a pallet, a container, or any other device to be manipulated, using an end-effector 16. In this example, robot 10 may be controlled to transport the element from one location to another location.

As shown in FIG. 1, end-effector 16 includes a fork comprised of two tines 20, 21 in this example. Other types of end-effectors may be used, such as a plate or a gripper. The tines may be configured for vertical movement in the directions of arrow 22. The vertical movement enables the tines to pick-up an element and to move the element to an appropriate vertical height for stacking. The vertical movement also enables the tines to reach a height of an element to be removed from a stack, a rack, or another location. The tines also may be configured for horizontal movement in the directions of arrow 23. In some examples, the tines are interconnected and, therefore, move together. In some examples, each tine may be configured for independent and separate horizontal movement along the directions of arrow 23. That is, each tine may move relative to the other tine to adjust the distance between the two (or pitch). This adjustment may be necessary to accommodate elements having different socket locations. In some examples, each tine may be configured for independent and separate vertical movement along the directions of arrow 23. In some implementations, one of the tines may be movable out of the way to allow a single tine to interact with an element or other element. For example, a tine 20 may be rotatable by 90° in the direction of arc 24, leaving tine 21 in position to interact with an element or other element located in front of robot 10. The other tine 21 may operate similarly.

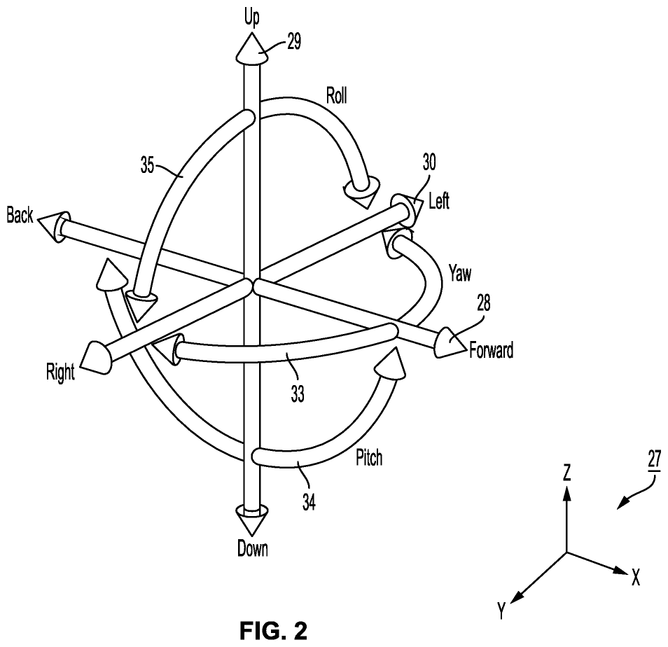

The end-effector, the robot body, or a combination of the end-effector and the robot body may move in three, four, five, or six degrees of freedom in order to move and to manipulate an element for lifting, stacking, removal, or movement. For example, the end-effector, the robot body, or a combination of the end-effector and the robot body may move in three, four, five, or six degrees of freedom in order to engage, to move, and to manipulate one element to place that one element on top of another element of similar or different type. For example, the end-effector, the robot body, or a combination of the end-effector and the robot body may move in three, four, five, or six degrees of freedom in order to engage, to move, and to manipulate one element to remove that element from atop another element of similar or different type. FIG. 2 shows movement in six degrees of freedom graphically relative to Cartesian X, Y, and Z axes 27. The six degrees of freedom include forward/backward (surge) 28, up/down (heave) 29, left/right (sway) 30, yaw 33, pitch 34, and roll 35.

In some implementations, the end-effector is controllable to move independently of the robot's body in three or more degrees of freedom. In some implementations, the end-effector is controllable to move independently of the robot's body in four or more degrees of freedom which include forward/backward, up/down, left/right, and at least one of yaw, pitch, or roll. In some implementations, the end-effector is controllable to move independently of the robot's body in at least five degrees of freedom which include forward/backward, up/down, left/right, and at least two of yaw, pitch, or roll. In some implementations, the end-effector is controllable to move independently of the robot's body in six degrees of freedom which include forward/backward, up/down, left/right, yaw, pitch, and roll. These movements enable movement of the element in three, four, five, or six degrees of freedom.

In some implementations, the robot's body is controllable to move in three degrees of freedom. In some implementations, the robot's body is controllable to move in at least four degrees of freedom which include forward/backward, up/down, left/right, and at least one of yaw, pitch, or roll. In some implementations, the robot's body is controllable to move in at least five degrees of freedom which include forward/backward, up/down, left/right, and at least two of yaw, pitch, or roll. In some implementations, the robot's body is controllable to move in six degrees of freedom which include forward/backward, up/down, left/right, yaw, pitch, and roll. These movements enable movement of the element in four, five, or six degrees of freedom.

Since the end-effector is connected to the robot's body, the end-effector may move along with the body. The end-effector may also be configured to make the above-described movements independently of the robot body. That is, the body may move in a number of degrees of freedom and the end-effector may move separately from the robot body in the same number of degrees of freedom, in fewer number of degrees of freedom, or in a greater number of degrees of freedom. For example, if the body moves forward, the end-effector may move forward along with the body but the end-effector may also move further forward or left/right independently of movement of the body.

In some implementations, the end-effector and the body are together controllable to move an element in three degrees of freedom. In some implementations, the end-effector and the body are together controllable to move an element in at least four degrees of freedom which include forward/backward, up/down, left/right, and at least one of yaw, pitch, or roll. In some implementations, the end-effector and the body are together controllable to move an element in at least five degrees of freedom which include forward/backward, up/down, left/right, and at least two of yaw, pitch, or roll. In some implementations, the end-effector and the body are together controllable to move an element in six degrees of freedom which include forward/backward, up/down, left/right, yaw, pitch, and roll. For example, the body may be configured to move forward/backward and left/right and the end-effector may be configured to move up/down and at least one of yaw, pitch, or roll (four degrees), at least two of yaw, pitch, or roll (five degrees), or all of yaw, pitch, or roll (six degrees). Different combinations of movements than those described here may be implemented.

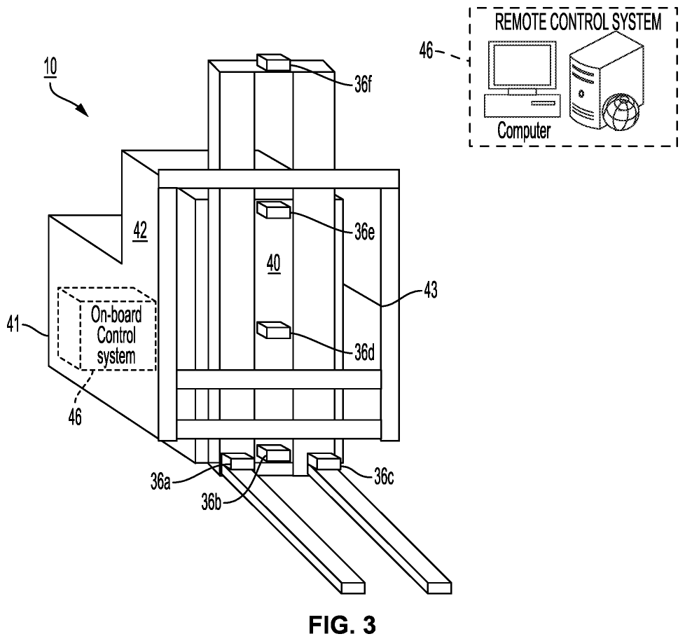

Referring also to the block diagram of FIG. 3, one or more sensors 36a, 36b, 36c, 36d, 36e, and 36f are located on robot 10 for use in detecting the location of the robot itself, for detecting an element to pick-up, and/or for detecting a location on which to place—for example, to stack—the element. The sensors are also usable to detect locations of alignment features on the elements and to track their location as the robot and/or the element moves relative to the stack. The sensors are configured to obtain 3D data at least from locations that are at least in front of the end-effector. Examples of sensors include 2D and 3D sensors. For example, robot 10 may include one or more 3D cameras, one or more light detection and ranging (LIDAR) scanners, one or more optical sensors, one or more sonar sensors, one or more time-of-flight (TOF) sensors, one or more radar sensors, one or more 2D camera sensors, one or more ultrasonic sensors, or any appropriate multiple numbers and/or combination thereof. To obtain 3D data using 2D sensors, multiple 2D sensors may be used. Notably, the example robot is not limited to these types of sensors.

In an example, robot 10 includes one or more 3D cameras at a front 40 of the robot. A 3D camera may capture, red, green, blue, and depth (RGBD) data. In this example, the front of the robot faces the direction of travel of the robot. In the example of FIG. 3, the front of the robot may include an arc spanning 180° or less from one side of the robot to the opposite side of the robot. In an example, robot 10 may include multiple LIDAR scanners at a front of the robot. Each LIDAR scanner is configured to detect objects within a sensing plane. Two or more LIDAR scanners may be configured and arranged to obtain 2D data in orthogonal sensing planes. This 2D data, when appropriately correlated and/or combined constitutes 3D information obtained from the front of the robot. Combinations of these and/or other sensors may be used to obtain 3D data representing the space in front of the robot. The 3D data may include 3D (e.g., Cartesian XYZ) coordinates representing the space.

In implementations that include multiple sensors on the front of the robot, the sensors may be located at different positions, for example at different heights. In addition, one or more the sensors may be movable on the robot. In some examples, sensors 36a, 36c may be located on, and movable with, the end-effector. A sensor located here enables the robot to detect and to image elements, such as a pallet or container, that are located directly in front of the end-effector. Data from such sensors enables the end-effector to identify sockets in the element and, therefore, facilitates entry of the end-effector into the sockets in the element. In some examples, one or more sensors may be located on the body of the robot. For example, one or more sensors 36d may be located at a mid-point of the robot, one or more sensors 36b may be located at a bottom of the robot, and/or one or more sensors 36e may be located above sensors 36d. One or more sensors 36f may be located at the top of the robot. Sensors strategically placed at these or other locations enable the robot to capture images of elements in front of the robot even when the robot is holding an element that blocks a sensor. Example elements include, but are not limited to, the following, a rack, a pallet, a fixed or movable device including a compatible interlocking mechanism, a stack of one or more elements, or a rack containing a stack of one or more element. For example, with proper placement, if one sensor is blocked—for example, by one or more element s on the end-effector, another sensor will not be blocked by those element s enabling for continuous sensing. Data captured by the sensors is sent the robot's control system for processing and use.

In some implementations, robot 10 may include additional sensors at locations other than the front of the robot. For example, sensors of the type described herein may be included on one or both sides of the robot and/or on the back of the robot. In this example, the back of the robot is the opposite side of the front of the robot. In the example of FIG. 3, the back 41 of the robot includes an arc spanning 180° or less from one side of the robot to the opposite side of the robot. In the example of FIG. 3, the sides 42, 43 of the robot may include an arc spanning 180° or less from the direction of travel of the robot to the direction opposite to the direction of travel of the robot. These sensors may assist in operations such as object detection and localization.

LIDAR scanners, 3D cameras, and/or any sensors constitute a vision system for the robot. Visual data obtained by the vision system may be used to determine a location of the robot within a space being traversed. In this regard, in some implementations, a control system 46 stores a map of the space to be traversed in computer memory. Components of control system 46 are shown in dashed lines in FIG. 3 because at least part of the control system may be internal to the robot. The map may be located on the robot or at any location that is accessible to the control system.

The map may include locations of landmarks, such as columns, corners, windows, poles, and other distinguishable features of the space that act as references for the robot. The map may include dimensions and distinguishing characteristics, such as color, shape, texture, and so forth of landmarks, such as columns, walls, corners, windows, poles, and other distinguishable features of the space that act as references for the robot. The map may also include measurements indicating the size of the space, measurements indicating the size and locations of the landmarks, measurements indicating distances between landmarks, and coordinate information identifying where the landmarks are located in the space. The control system uses information in the map to move throughout the space and uses visual data from the vision system and data from the map to determine a location of the robot within the space. For example, the robot may identify the locations of three landmarks within the space. By knowing where the robot is relative to these landmarks, the locations of the landmarks on the map and thus within the space, and the distances between the landmarks, the control system can determine the location of the robot within the space. This information may be used to locate an element to pick-up or to locate another element on which to place—for example, to stack—the element the robot is holding or will hold. Examples of other elements include an element of like type, a compatible interlocking compatible device such as another element of like or different type, or a rack.

In some implementations, an on-board control system on the robot may use a pre-planned route through the map to identify where to locate an element to pick-up or to locate one or more of the following on which to place to pick up or to place an element: a stack of elements, a compatible interlocking device, or a rack. As described herein, a control system on the robot may not use a pre-planned route through the map to identify where to locate an element to pick-up or to locate one of the other elements from which to pick-up or to place the element. In an example, the robot may move through and around the space and, upon reaching an object, attempt to detect and to identify an element that the robot is controlled to move. In some examples, identification and detection may be performed by capturing image data in a region of interest containing the element, filtering the image data to produce filtered data having less of an amount of data than the captured image data, and identifying components of the element by analyzing the filtered data using a deterministic process. The identification process may also include referencing a database comprised of a library containing attributes of elements. In some cases, after the robot identifies an element of interest, the robot may the move through and around the space to identify one of the other elements on which to place the element that the robot is holding.

The location of the other element may be pre-programmed or the robot may search through the space using its sensor systems to identify the other element. In this regard, in some implementations, the element or the other element on which to place the element the robot is holding may contain indicia such as a bar code, a QR code, or a serial number. The robot may identify such indicia on the element and other element, compare the identified indicia and, when a match is detected, determine that the element is to be placed on the other element. In some implementations, these operations may be performed based on dimensions of the element and the other element, or other distinguishing characteristics—such as color or markings—on the element and the other element. For example, operations may be executed by the control system to determine where to place a pallet or other element or from where to remove a pallet or other element. The operations may include detecting a rack containing a volume in which to place or from which to remove an element, pointing a sensor above a bottom of the rack to a region of interest, detecting the volume based on 3D data within a first part of the region of interest and a lack of 3D data within a second part of the region of interest, and determining, based on the 3D data and dimensions of the element, whether the volume is large enough to fit the element.

Control system 46 may include circuitry and/or an on-board computing system to control operations of the robot. The circuitry or on-board computing system is “on-board” in the sense that it is located on the robot itself. The control system may include, for example, one or more microcontrollers, one or more microprocessors, programmable logic such as a field-programmable gate array (FPGA), one or more application-specific integrated circuits (ASICs), solid state circuitry, or any appropriate combination of two or more of these types of processing devices. In some implementations, on-board components of the control system may communicate with a remote computing system. This computing system is remote in the sense that it is not located on the robot itself. For example, the control system can also include computing resources distributed to a remote—for example, a centralized or cloud—service at least a portion of which is not on-board the robot. Commands provide by the remote computing system may be transferred for execution by an on-board computing system.

In some implementations, the control system includes only on-board components. In some implementations, the control system includes a combination of on-board components and the remote computing system. In some implementations, the control system may be configured—for example programmed—to implement control functions and robot movement absent either local or remote input from a user. In some implementations, the control system may be configured to implement control functions, including localization, based at least in part on input from a user.

In some implementations, the remote control system may include a fleet control system. The fleet control system may include one or more computing devices that operate together to control, to influence, or to instruct multiple robots of the type described herein. For example, the fleet control system may be configured to coordinate operations of multiple robots, including instructing movement of a robot to a position where an element is located and to a position where the element is to be stacked (for example, placed). For example, the fleet control system may be configured to coordinate operations of multiple robots, including instructing movement of a robot to a position where an element is to be picked-up. In some implementations, the fleet control system may store, maintain, and update the map of the space in which the robot or robots are to operate. The map may be accessed by each robot through the fleet control system or the map may be downloaded periodically, intermittently, or sporadically to all or some robots operating in the space. For example, the robot may use the map to position itself proximate to an element in order to pick-up the element; the robot may use the map to navigate towards another element on which the robot is to place the element that the robot has picked-up; and the robot may use the map to position itself proximate to the other element on which the robot is to place the element that the robot has picked-up. In this example, positioning may include moving robot so that its end-effector aligns to sockets in the element that is to be picked-up, which may include moving the body, the end-effector, or both. The map may also be used to identify an existing rack or stack from which to pick-up an element.

In some implementations, the control system, including the remote portions thereof, may be distributed among multiple robots operating in the space. For example, one of the robots may receive the map—for example, from a fleet controller—and distribute the map to robots operating locally within the space. Similarly, one or more robots within the space may send command and control signals to other robots.

The control system, whether on-board the robot, remote from the robot, or a combination of on-board and remote, may include computer memory storing a database comprising a library of data identifying different types of elements and attributes of the different types of elements. For example, the database may include attributes identifying the make of an element, the model of an element, the number of sockets in an element, the dimensions of an element including length, width, and depth (XYZ), the material of which the element is made, the weight of the element, the element alignment (or stacking) features, indicia or markings on the elements such as color, serial number, bar codes, QR codes, and the like, and any other appropriate information that the robot may need to pick-up the element, to move the element, and/or to stack the element on another element such as a rack or compatible interlocking device such as another element. This information may be usable by the robot to identify the element and to control its body and/or its end-effector to pick-up and to move the element. For example, an on-board control system on the robot may obtain information from a local or remote database of this type and may use that information to recognize the element and to pick-up and/or to stack the element as described herein.

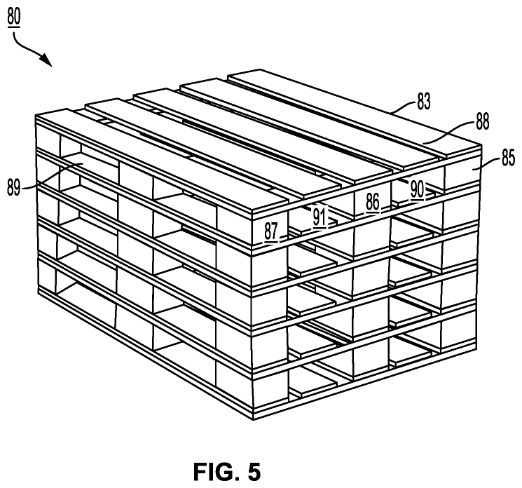

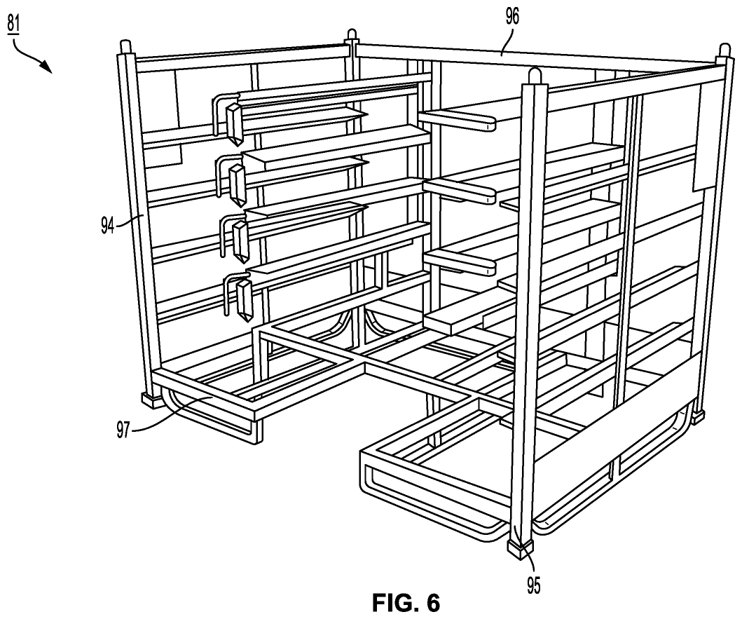

In this regard, different types of elements may be comprised of different types of components. For example, a pallet, such as pallet 83 of FIG. 5, may include pillars 85, 86, and 87, and decks 88 and 89. Pallet 83 may also include sockets 90 and 91. For example, a rack, such as rack 81 of FIG. 6, may include vertical pillars such as 94, 95 and horizontal beams such as 96, 97. Techniques may be used to detect components of an element such as a pallet prior to manipulating the element.

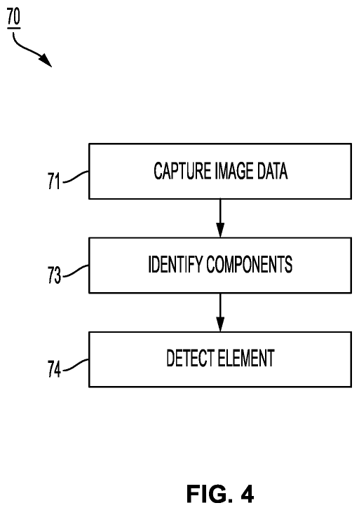

Referring to FIG. 4, the following operations may be used to detect an element, such as a pallet, using a robot. The operations may be performed in whole or in part by the robot's control system which, as described herein, may be on-board or remote. The operations may be performed in whole or in part using one or more computing systems that are separate from, and in communication with, the robot's control system. The robot may be controlled to move to the vicinity of an element of interest and to position or to direct its sensors based on an expected location of the element. The expected location may be programmed into the control system or obtained from a remote computing system. In FIG. 4, operations 70 to detect that element include using a sensor on the autonomous vehicle to capture (71) image data in a region of interest containing an element. For example, one or more of sensors 36a, 36b, 36c, 36d, 36e, or 36f may be directed at the element to obtain image data representing components of the element. In some implementations, the image data may be 3D data captured by sensors such as a 3D camera or multiple LIDAR sensors.

Operations 70 include identifying (73) components of the element by analyzing the detected data using a deterministic process. An example deterministic process includes a process having a behavior that is entirely determined by its initial state and inputs, and that is not random or stochastic. In example, components of the element may include pillars, decks, or beams, as described previously.

Operations for identifying (73) the components may include locating one or multiple structures represented by the detected data that extend along a first dimension and that are separated by a predefined space. Operations for identifying (73) the components may include locating one or multiple structures represented by the data that extend along a second, different dimension and that are separated by a predefined space. For example, these operations may include locating structures that extend along a horizontal dimension (such as decks) and structures that extend along a vertical dimension (such as pillars). A known or expected geometry of the element that is being identified dictates the expected locations and spaces between the various structures. For example, for a pallet having three pillars, the expected distance between two adjacent pillars may be X (X>1) centimeters (cm) and the expected distance between two decks may be Y (Y>1) cm.

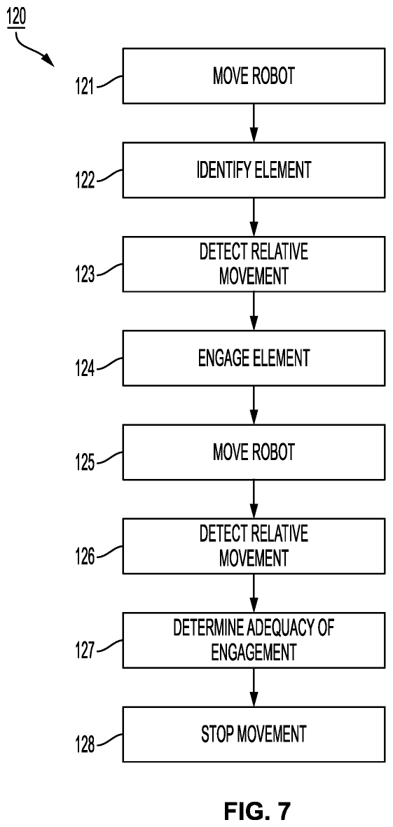

Detecting (74) an element may include, after two or more components are identified, comparing a configuration of the components to an expected configuration of the element from the library. If the components compare favorably to the expected configuration—for example, the components match or are within an acceptable error of the expected configuration, then the components are recognized as the element. Referring to FIG. 7, the following operations may be used for engaging and manipulating the element using an autonomous vehicle such as a robot. For example, the operations may be performed while placing one element on top of another element of the same or different type (such as on a rack), or moving one element off of another element of the same or different type. For example, operations 120 may be executed to place a pallet on a rack or stack of other pallets or to remove the pallet from the rack or stack of other pallets. The operations may be performed in whole or in part by the robot's control system which, as described herein, may be on-board or remote. The operations may be performed in whole or in part using one or more computing systems that are separate from, and in communication with, the robot's control system.

Operations 120 includes engaging an element. In this regard, the robot may be controlled to move (121) to a location of the element as described herein. The element may be identified (122) using operations 70 for example. As described below, the robot may engage the element. In the example of robot 10 and a pallet, end-effector 16 may fit into the sockets of the pallet to implement the engagement.

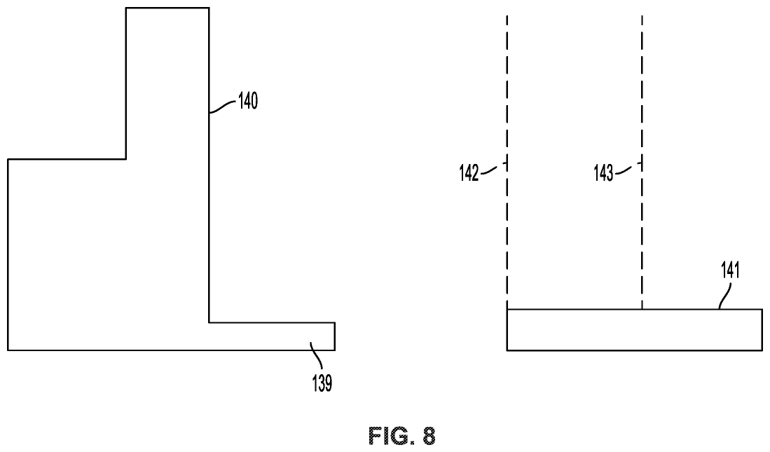

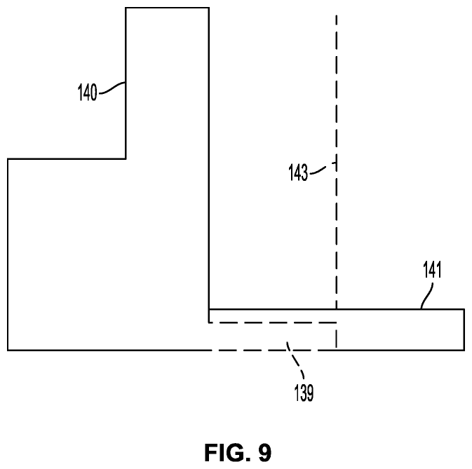

Prior to engagement with the element, operations 120 include detecting (123) relative movement between the robot and the element. Before the robot is engaged with the element, there should be relative movement that is consistent with the speed of the robot towards the element. The relative movement is detected by detecting a distance between the robot and the element during movement of the robot. The distance may be detected using a LIDAR system, a 3D camera system, one or more ultrasonic sensors, or any other sensors described herein or combinations thereof. Accordingly, prior to engagement, the robot is controlled to continue to move while there is relative movement between the robot and the element. At some point during this relative movement, the robot begins to engage (124) the element. Engagement may be full or partial. In this regard, the distance detected by the sensors may be used to determine whether the end-effector (and thus the robot) is fully engaged with the element, partially engaged with the element, or disengaged from the element. For example, sensor data representing the distance may be sent to the control system, which processes the sensor data over time to detect relative movement. In the example of FIG. 8, robot 140 is disengaged with pallet 141 when the robot's end-effector 139 is prior to line 142. When the robot's end-effector 139 is between lines 142 and 143, robot 140 is partially engaged with pallet 141. When the robot's end-effector 139 reaches or is past line 143, robot 140 is fully engaged with pallet 141 as shown in FIG. 9.

Referring back to FIG. 7, following full engagement with the element, the robot may be controlled to move (125) either to place the element at a location such as on a stack or rack, or to remove the element from a location such as off of the stack or rack.

In this regard, relative movement, if any, between the autonomous vehicle and the element continues to be detected during the entire period that the robot interacts with the element. Following full engagement and during placement or removal of the element, however, movement of the element relative to the robot is not desired, since such movement is evidence of slippage, which may be caused by inadequate engagement between the end-effector and the element. That is, during this period, it is best that the robot and the element remain static relative to each other. If the robot's end-effector is fully engaged with a pallet and is being moved away from a location to move the pallet from that location, movement of the end-effector relative to the pallet may indicate that the pallet is slipping across the end-effector. Likewise, if the robot's end-effector is fully engaged with a pallet and the pallet is being moved into a location such as a stack of pallets, movement of the end-effector relative to the pallet may indicate that the pallet is slipping across the end-effector. In the former situation, the result may be that the end-effector does not have full engagement with the pallet, which may cause it to drop. In the latter situation, the result may be that the end-effector pushes the pallet off of the other side of the stack or otherwise places the pallet in a manner that is not safe.

Accordingly, operations 120 include detecting (126) relative movement of an element following full engagement between the robot's end-effector and the element. In response to detecting any relative movement or to detecting more than a predefined amount of acceptable relative movement (e.g., in the single-digit millimeter or single-digit centimeter range), a determination is made (127) by the control system that the engagement is inadequate for the robot to continue manipulating the element. In an example, the engagement may be inadequate when the robot is moving forward and the element moves relative to the robot causing the distance between the element and the robot (for example, the robot's body) to change. Forward movement may include, for example, placing the element on a rack or stack. In an example, the engagement is inadequate when the robot is moving backward and the element moves relative to the robot causing the distance between the robot (for example, the robot's body) and the element to change. Backward movement may include, for example, removing the element from a rack or stack. If there is no relative movement or less than a threshold amount of relative movement between the element (e.g., a pallet) and the end-effector, the engagement between the end-effectors and the element may be deemed to be adequate and there may be no problems with the current manipulation operations.

Following detection of relative movement while the robot's end-effector and the element are fully engaged, the robot may be controlled (128) to stop movement in either forward or backward directions. In this case, the element may be set down and the robot may disengage. In some cases, there may be manual intervention or intervention using another robot to correct the inadequate engagement. In some cases, the robot may be controlled to disengage and then to reengage the element, e.g., to try again. The example autonomous vehicles described herein may be controlled, at least in part, using one or more computer program products, e.g., one or more computer program tangibly embodied in one or more information carriers, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the testing can be performed by one or more programmable processors executing one or more computer programs to perform the functions described herein. All or part of the testing can be implemented using special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks. Machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

Any mechanical or electrical connection herein may include a direct physical connection or an indirect connection that includes intervening components.

Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A method of manipulating an element using an autonomous vehicle, the method comprising:
following engagement with the element and during movement of the autonomous vehicle, detecting relative movement between the autonomous vehicle and the element;
in response to detecting the relative movement, making a determination that the engagement is inadequate for the autonomous vehicle to continue manipulating the element; and
controlling the autonomous vehicle based on the determination.

2. The method of claim 1, further comprising:
prior to the engagement with the element, detecting relative movement between the autonomous vehicle and the element; and
controlling the autonomous vehicle to continue to move based on detecting relative movement prior to engagement.

3. The method of claim 1, wherein the relative movement is detected by detecting a distance between the autonomous vehicle and the element during movement of the autonomous vehicle;
wherein the autonomous vehicle comprises an end-effector configured to engage with the element; and
wherein the distance indicates whether the end-effector is fully engaged with the element, partially engaged with the element, or disengaged from the element.

4. The method of claim 3, wherein the engagement is inadequate when the autonomous vehicle is moving forward and the element moves relative to the autonomous vehicle causing the distance to change.

5. The method of claim 3, wherein the engagement is inadequate when the autonomous vehicle is moving backward and the element moves relative to the autonomous vehicle causing the distance to change.

6. The method of claim 1, wherein controlling the autonomous vehicle comprises stopping movement of the autonomous vehicle in either forward or backward directions.

7. The method of claim 1, wherein the relative movement is detected by detecting a distance between the autonomous vehicle and the element during movement of the autonomous vehicle; and
wherein detecting the distance is performed using a light detection and ranging (LIDAR) system.

8. The method of claim 1, wherein the relative movement is detected by detecting a distance between the autonomous vehicle and the element during movement of the autonomous vehicle; and
wherein detecting the distance is performed using a three-dimensional (3D) camera.

9. The method of claim 1, wherein the relative movement is detected by detecting a distance between the autonomous vehicle and the element during movement of the autonomous vehicle; and
wherein detecting the distance is performed using one or more ultrasonic sensors.

10. The method of claim 1, further comprising:
detecting that the autonomous vehicle is moving based on encoders that detect tire rotation.

11. The method of claim 1, further comprising:
detecting that the autonomous vehicle is moving using laser-based detection relative to the environment.

12. The method of claim 1, further comprising:
detecting that the autonomous vehicle is moving using a three-dimensional (3D) camera.

13. A system comprising:
an autonomous vehicle comprising a sensor to generate data based on relative movement between the autonomous vehicle and an element, the autonomous vehicle further comprising an end-effector to engage the element; and
a control system to perform operations comprising:
following full engagement between the end-effector and the element and during movement of the autonomous vehicle, receiving the data from the sensor based on the relative movement between the autonomous vehicle and the element;
in response to the relative movement, making a determination that the engagement is inadequate for the autonomous vehicle to continue manipulating the element; and
controlling the autonomous vehicle based on the determination.

14. The system of claim 13, wherein the control system is configured to perform operations comprising:
prior to the full engagement with the element, receiving the data from the sensor based on relative movement between the autonomous vehicle and the element; and
controlling the autonomous vehicle to continue to move based on the relative movement prior to engagement.

15. The system of claim 13, wherein the data represents a distance between the autonomous vehicle and the element during movement of the autonomous vehicle; and
wherein the distance indicates whether the end-effector is fully engaged with the element, partially engaged with the element, or disengaged from the element.

16. The system of claim 15, wherein the engagement is inadequate when the autonomous vehicle is moving forward and the element moves relative to the autonomous vehicle causing the distance to change.

17. The system of claim 15, wherein the engagement is inadequate when the autonomous vehicle is moving backward and the element moves relative to the autonomous vehicle causing the distance to change.

18. The system of claim 13, wherein controlling the autonomous vehicle comprises stopping movement of the autonomous vehicle in either forward or backward directions.

19. The system of claim 13, wherein the sensor comprises a light detection and ranging (LIDAR) system.

20. The system of claim 13, wherein the sensor comprises one or more three-dimensional (3D) cameras.

21. The system of claim 13, wherein the sensor comprises one or more ultrasonic sensors.

22. The system of claim 13, wherein the autonomous vehicle comprises one or more encoders to detect tire rotation and to output data to the control system based on the tire rotation.
